(19) United States
(12) Patent Application Publication
(10) Pub. No.: US 2008/0301666 A1
(43) Pub. Date: Dec. 4, 2008

(54) SYSTEM FOR AGGREGATING CONTENT DATA AND METHODS RELATING TO ANALYSIS OF SAME

(76) Inventors: Susan GORDON, Tel-Aviv (IL); Noam Gordon, Tel-Aviv (IL); Shay Finkelstein, Herzlia (IL)

Correspondence Address: SUSAN GORDON, 5225 POOKS HILL ROAD, APT 1429 SOUTH, BETHESDA, MD, 20814, US

(21) Appl. No.: 11/755,582

(22) Filed: May 30, 2007

(51) Int. Cl. G06F 9/44

(52) U.S. Cl. 717/172

(57) ABSTRACT

Enables the aggregation and analysis of content data and optionally provides a configuration management system that is able to seamlessly make software upgrade recommendations based on the current system. Provides configuration management services for networked client computers. Includes various modules that provide functionalities such as: 1) identifying a configuration of each client computer coupled to the system; 2) recording a configuration associated with each client computer to a server module that collects the aggregated data; 3) analyzing client configuration data, aggregated client system configuration data, and data obtained from hardware/software vendors; and, 4) recommending actions to each specific client computer for hardware and/or software updates and additions, and/or reporting statistics related to other computer configurations; and/or, 5) enabling a user to revert their computer back to an older configuration. An additional option could include dynamically gathering data during the software installation process and storing that data on the server module.

### BACKGROUND OF THE INVENTION

1. Field of the Invention

Embodiments of the invention described herein pertain to the field of computer systems. More particularly, but not by way of limitation, one or more embodiments of the invention enable the aggregation and analysis of content data from networked computer systems. Systems implementing one or more aspects of the invention also enable networked computer users to receive configuration management services and thereby maintain a current system profile and/or modify the system profile to follow third-party recommendations.

2. Description of the Related Art

The complexity of the computer system has increased significantly as new computer and input/output (I/O) device designs, associated software and operating systems move into production. Computer components and chipsets have increased in capacity, capabilities, and/or speed with each new generation. A wide variety of I/O devices with various performance capabilities are typically included in a computer. Examples of I/O devices include keyboards, pointing devices, scanners, disk drives, CD-ROM drives, printers, display monitors, local area network (LAN) adapters, FAX/modem boards, soundboards, and other such devices that add one or more functions to the computer. Computer components, I/O devices, and their associated software come in various models with varying operational characteristics and are produced by many different manufacturers. The number of distinct configurations in a computer is very large and each set generally has multiple nuances associated with a proper configuration. While most computers are initially well-configured prior to their shipment to the end user, computer manufacturers and other vendors that provide computer hardware and software lack a mechanism for determining what modifications are made once in the computer is in the field, and what the consequences of such modifications might have on system operations. Because of the complexities involved in system and software compatibility, computer performance is often reduced, and inter-operability issues arise when the end-user makes changes to the configuration.

Configuration data is a collection of configuration parameters and data objects that control and modify at least a portion of the computer system behavior. Complex computer systems typically have a large number of such configuration parameters, often ranging in the hundreds and sometimes thousands of parameters. Often cross-dependencies are observed, where a change of one parameter will cause unforeseen and unintended system behavior requiring change to another parameter. Configuring computer systems at this stage is typically difficult and cumbersome and can require a high level of knowledge, skill and experience.

As computer systems become more and more complex, there will be a need for systems that provide comprehensive and sophisticated configuration management control. In some cases, computer vendors try to meet this need by providing diagnostic software with new computer systems at the time of purchase. Alternatively, users may purchase a diagnostic software package at a retail store or through the Internet. There are, however, drawbacks to both of these methods for delivering diagnostic software to users, especially when such diagnostic software does not take into account new components and peripherals added to the system. Moreover, such diagnostic software does not make recommendations to improve system performance when a vendor provides updated software and drivers.

For at least the reasons described above there is a need for a system that aggregates and analyzes content data and provides manufactures and other vendors with data that enables more accurate upgrade recommendations for purposes of enhancing product reliability and component compatibility.

### BRIEF SUMMARY OF THE INVENTION

One or more embodiments of the invention enable the aggregation and analysis of content data and optionally provide a configuration management system that is able to seamlessly make software upgrade recommendations based on the current system. Systems and methods are disclosed which provide configuration management services for the networked client computers. The service includes various modules that provide functionalities such as: 1) identifying a configuration of each client computer coupled to the system; 2) recording a configuration associated with each client computer to a server module that collects the aggregated data; 3) analyzing client configuration data, aggregated client system configuration data, and data obtained from hardware/software vendors; and, 4) recommending actions to each specific client computer for hardware and/or software updates and additions, and/or reporting statistics related to other computer configurations; and/or, 5) enabling a user to revert their computer back to an older configuration. An additional option could include dynamically gathering data during the software installation process and storing that data on the server module.

The current configuration of the client computer system is compared in a database of the latest hardware and software version information from vendors, including generic drivers and open source software. A recommendation report is provided and enables the user of the client computer system to download the latest software update and/or hardware/software additions to enhance the current configuration of the client computer system. The recommendation of the hardware/software additions is based at least partially upon the information gathered and the aggregated information from a cumulative base of other client computer systems. Systems embodying one or more aspects of the invention also provide a reporting feature based on analysis of the aggregated data as a whole. The system thus enables observations about usages in the end-user population as a whole.

In one embodiment of the invention, recommendations for enhancing a client computer system are provided. This method includes executing a configuration management program stored in a computer-readable medium on the client computer system, scanning the current configuration of the client computer system, comparing some of the information gathered from the scanning step with both the product specifications contained in a database and the aggregated client computer configurations in a database, and identifying recommendations for additions and updates of software/hardware to enhance the computer system.

### BRIEF DESCRIPTION OF THE DRAWINGS

The above and other aspects, features and advantages of the invention will be more apparent from the following more particular description thereof, presented in conjunction with the following drawings wherein:

FIG. 1 is a block diagram showing a one or more modules used in accordance with one or more embodiments of the invention.

FIG. 2 is flow diagram showing a methodology adopted in one or more embodiments of the invention.

FIG. 3 is flow diagram showing a methodology adopted in one or more embodiments of the invention.

FIG. 4 is a system diagram showing disparate systems coupled to a network in accordance with one or more embodiments of the invention.

FIG. 5 is flow diagram showing a methodology adopted in one or more embodiments of the invention.

### DETAILED DESCRIPTION

A configuration management system and methods relating to the aggregation and analysis of configuration data will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

Systems and methods are disclosed which provide configuration management services for a networked client computer, mapping of various vendor devices to create an updated repository of real-time driver and software information, and complimentary software information and hardware ranking or other rating information, based upon aggregate data collected from a plurality of computers.

The configuration management service includes various modules that provide functions for: 1) identifying the current configuration of a client computer; 2) recording data indicative of the current configuration of client computer to a server module; 3) analyzing and comparing the client configuration data, aggregated client system configuration data, and data obtained from hardware/software vendors; 4) recommending actions to client computer for hardware and/or software update and additions and/or reporting statistics related to other computer configurations; and/or, 6) enabling a user to revert their computer back to an older configuration. An additional option could include dynamically gathering data during the software installation process and the storing the gathered data on the server module.

The term software or computer program, as used herein, is defined as a sequence of machine-readable instructions on a media designed for execution on a computer system. Software refers to firmware, operating system software, device driver software, application software, and/or middleware.

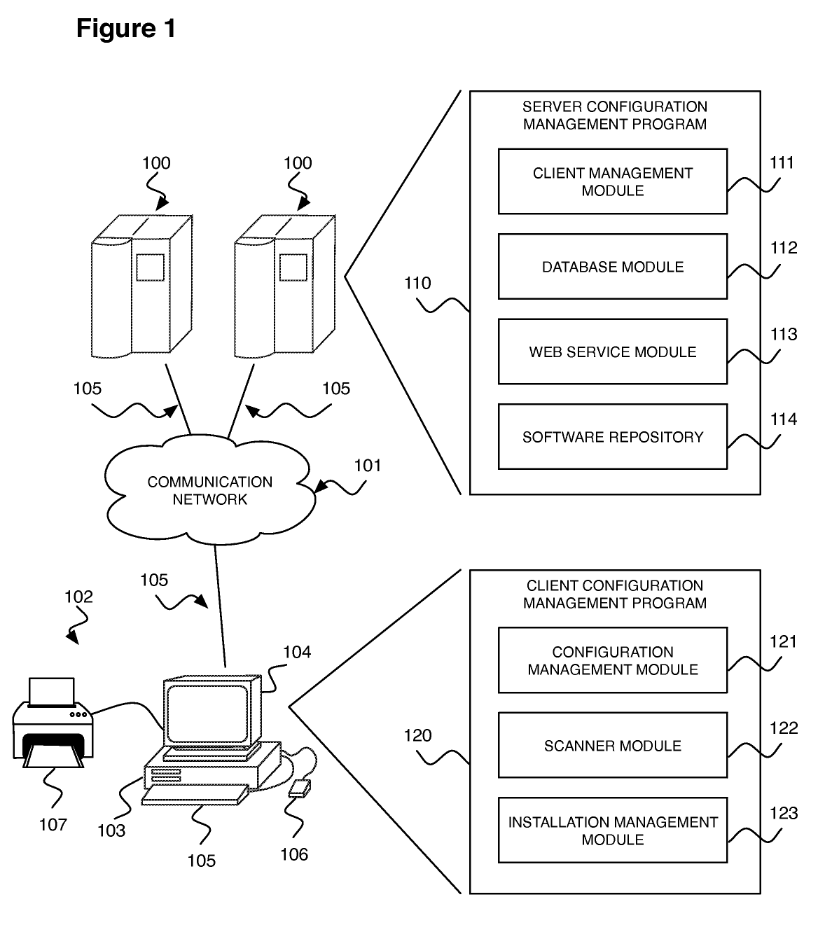

FIG. 1 shows the manner of a typical computer network system for facilitating execution of an embodiment of the invention includes one or more server devices 100 connected via a communication network 101 to a client computer system 102. In an embodiment, the communication network 101 is a partially public or a wholly public network such as the Internet. The communication network 101 may also be a private network or include one or more distinct or logical private networks (e.g., virtual private networks or wide area networks). Additionally, the communication links 105 to and from the network 101 can be wired or wireless (i.e., terrestrial- or satellite-based transceivers).

A typical client computer system configuration 102 is shown. Computer 103, for instance, may contain a motherboard, sometimes referred to as the main board, system board, logic board, or even main card or mother card. Typically, all of the basic circuitry and components required for the computer to function are either contained in or attached to the motherboard such as microprocessor or CPU, controller or chipset, memory modules, serial and parallel ports, data storage devices, expansion slots, power supply, internal cache, external cache, and various cards such as a modem card, video card, network card, and sound card. External hardware components may include, for example, I/O devices such as a monitor 103, keyboard 105, mouse 106, printer 107, scanner, or any temporarily connected device such as a camera, personal digital assistant (PDA), or data storage device. The I/O connection link between I/O device and computer 102 can be wired (i.e., USB, RFC 1394, SCSI, PCI, or other wired I/O connection) or wireless (i.e., IEEE 802.11, Bluetooth, 2.4 GHz digital cordless technology, IrDA, or other wireless I/O connection).

A number of program modules may be stored on the data storage device including an operating system, one or more application programs, other program modules, and program data. Examples of the data storage device include hard disk, magnetic disk, optical disk, ROM, or RAM. It should be appreciated by readers that any type of computer-readable media which can store data accessible by a computer, such as magnetic cassettes, flash memory cards, digital video disks, removable drive cartridges, random access memories, read only memories, and the like, may be used in the exemplary client computer system. To manage physical resources, the operating system can include one or more device drivers. The device drivers provide standard software interfaces allowing other system components to access the controlled device. For example, the device driver may be a video or any other type of device driver. Device drivers can also provide device specific control, resource management, initialization, and fault handling for the controlled device.

A client computer system 102 hosts client configuration management program 120, including configuration management module 121, scanner module 122, and installation management module 123. Client configuration management program 120 is typically embodied in executable software, which may be run from client computer 103, and which may be partially or fully downloaded from the server 100 via network 101 to client computer 103.

Configuration management module 121 is programmed to interface with users of a client computer system and enable the users to manage software associated with configuration of the client computer system. Configuration management module 121 gathers the data representation indicative of the configuration data of the client computer system through scanner module 122 and communicates various management tasks to and from server 100 hosting server configuration management program 110.

Scanner module 122 is programmed to scan and identify the current configuration of client computer system 102 by accessing data indicative of identification and parameters for both hardware and software associated with the client computer configuration. The extracted data is then mapped into a client system data representation of the configuration data. In one embodiment of the invention, the client system data representation of the configuration data is in the form of XML (eXtensible Markup Language) configuration data. The scanner module may include an XML parser to analyze and validate the XML configuration data by applying the XML schema data to check and ensure that the XML configuration data meets the required form before being sent to server 100.

For example, in the Windows operating system, scanner module 122 can enumerate hardware devices in the client computer system via SetupAPI within Microsoft Software Development Kit (SDK), and then perform an inquiry on each device to identify whether the device is its own, and finally retrieve a device handle as inserted in the registry by the manufacturer. The software scanning is also performed using, for example, standard Win32 API to scan and identify executable by using IPersistFile interface and extract configuration data by VerQueryValue and GetFileVersionInfo API to read the executable block version. The client configuration data is then hashed using a predetermined protocol and wrapped into an XML configuration data to be sent to the server 100.

In practice, client computer system 102 typically includes various software programs that periodically may require the performance of software installation procedure and subsequent utilization of the installed software. Installation management module 123 receives recommendation data from server 100 hosting server configuration management program 110 and the information contained in the recommendation data enables users to simplify the task of installing or updating software on the client computer system by presenting recommendations including hyperlinks to enable clients to download software update.

Systems embodying one or more aspects of the invention also provide recommendation packages that are optionally made available to end-users for installation and use. Third-party users are provided with an interface for identifying software and extensions or plug-ins to such software and are able to create recommendation packages of their choosing. A user may assemble a recommendation package involving any software and extensions, plug-ins or complements thereto. A user who, for instance, prefers a certain group of plug-ins to Adobe Photoshop™ might assemble a recommendation package that lists this favored grouping. Users can also assemble a group of complementary programs that work well for a particular task. A graphic designer may, for instance, identify a set of extensions to the Firefox™ web browser and assemble a recommendation package based on the premise that such extensions are advantageous to people in similar professions. Other users are able to view the various recommendation packages and select a package for installation on their own system. To assist with the creation of these recommendation packages, a server module presents a creation interface which presents a list of various software programs and their extensions or plug-ins. Using this list and any additions the recommending user may wish to contribute, a recommendation package is made. In its initial form the recommendation package comprises a list presented by a recommending user. Once submitted via the creation interface the list is stored on the server side and posted to a presentation interface, such as a web page, where others can view the list. If the programs and other components, extensions or plug-ins are stored on the server or accessible to the server or an administrator thereof, the contents of the recommendation package may be made available for download. An assembly module on the server side may, for example, use the list to generate a recommendation package for download where the package contains all the software identified on the list in a single bundle. In cases where purchase or licensing is required, downloading users must submit the required information in order to use authorized forms of the software. A margin on top of the software cost may optionally be charged for assembly of the recommendation package, and if desired by the system operator, shared with the recommending user. Performance metrics and other interoperability factors associated with each recommendation package may be assembled by the system and used to rank the various packages. User ratings may also influence which lists are presented to others for download. The servers tasked with handling the recommendation package may work in conjunction with and/or be separable from the servers such as server 100 hosting the configuration management program 110.

One or more servers 100 hosts server configuration management program 110 comprising client management module 111, database module 112, web service module 113, and software repository 114. Client management module 111 communicates with client configuration management program on a client computer system 102 via communication network 101. Client management module 111 receives configuration data representation from a client configuration management program and automatically identifies older version of existing software program by comparing latest product specifications on database module 112. The information on latest product specification data is gathered from vendors and stored on a database (e.g., a relational database) of the database module 112. The product specifications gathered from vendors may include generic drivers and open source software. The comparison of software version with product specification data is one part of a process used to create recommendations on new software to install. The software version comparison process is performed through various algorithms which account for different version formats, the existence of generic drivers for various hardware types, and the like.

Database module 112 also stores aggregated client system configuration data on a database, which is typically implemented as one or more files of the server system. This database module is comprised of scripts that constantly gather and analyze data and statistics of an aggregated base of cumulative client computer system configurations, which also includes data representation indicative of the location of client computer system. In addition to the aforementioned software update recommendations, various data processing techniques described herein are used to create various recommendations based on the gathered data. Such recommendations may include top ten installed software based on location/company building, upgrades to hardware/software based on the public preference, plugins to software already installed on the user computer system, software X based on users who have software Y installed, and the other data processing techniques. The recommendations may be posted on web service module 114 or be sent as recommendation data to client computer 103 hosting client configuration management program 120.

The system may optionally include software repository 114 that store software programs and data on one or more data storage device including client configuration management program which may be uploaded to a client computer 103 through web service module 114. Software repository 114 optionally includes updated software packages sent by vendors for client to download.

In one embodiment, a server 100 comprises a computer that includes off-the-shelf, commodity hardware and software. For example, the hardware is based on an x86 processor. The server software includes the LAMP stack, which includes a Linux operating system (available from, for example, Red Hat, Inc., of Raleigh, N.C.), an Apache HyperText Transfer Protocol (HTTP) server (available from The Apache Software Foundation of Forest Hill, Md.), a MySQL database (available from MySQL AB of Sweden), and support for scripts written in languages such as Perl, PHP, and Python.

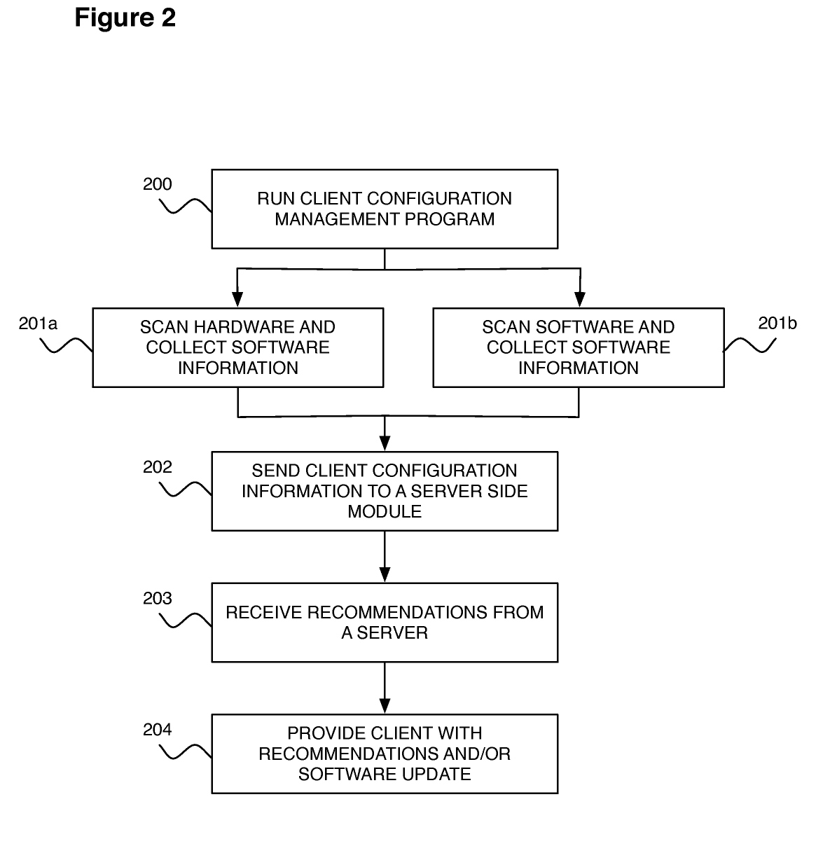

FIG. 2 illustrates a flowchart showing the manner of typical steps on a client computer system for facilitating execution of the invention according to one embodiment and begins with execution of a client configuration management program 120 on a client computer at the step 200. The execution of the client configuration management program 120 may be initiated in various ways. For example, an individual user may execute the program through a plugin on a website. The configuration management program may run wholly or partially from a server computer over the Internet, or may be downloaded to client computer at that time to run locally. Client configuration management program may be resident on the networked client computer or accessible over a local or other computer network. These and other variations are considered. In any case, the execution of the client configuration management program may be performed automatically in response to a single user request.

The scanning step may include one or both tasks 201a and 201b performed by the scanner module 122 of the client configuration management program 120. In those instances scanning and collecting of the data indicative of identification and parameters for hardware and software associated with the client computer system, and the extracted data is then mapped into data representation of that configuration data. The client system configuration data is then communicated electronically via a network 101 to a server 100 hosting server configuration management program 110.

Recommendation data are received from the server 100 at step 203 enabling the client configuration management program to interface with user by providing recommendations and enable the user to receive software updates and/or additions at step 204. The step of recommending, including software/hardware update, upgrade and additions, may include, for example, one or more order forms that can be sent directly to a vendor (or multiple vendors as the case may be) for ordering and delivery of recommended components. The embodiment also contemplates generation of the recommendations with hyperlinks to vendor websites that allows user to download software update components directly from the vendor website.

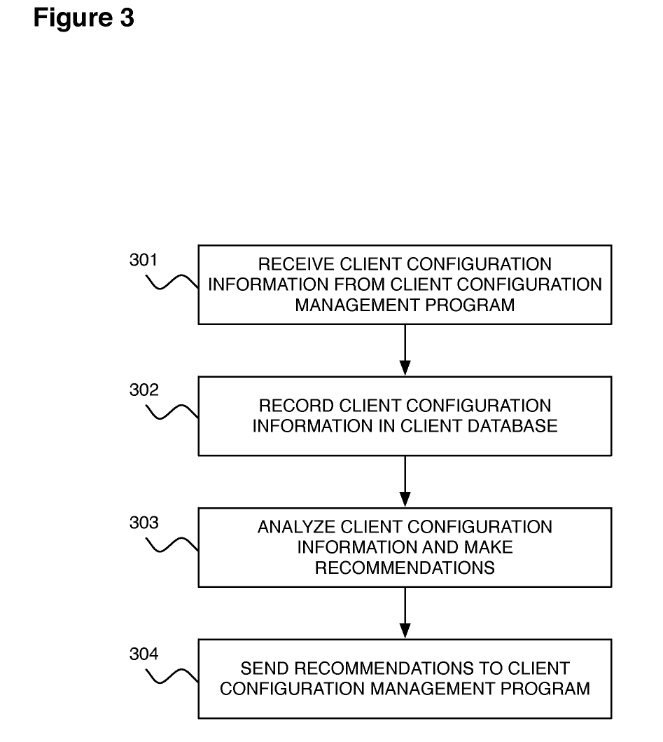

FIG. 3 illustrates a flowchart illustrating the manner of typical steps on a server system 100 for facilitating execution of the invention according to one embodiment begins with receiving of a client system configuration information at the step 301 which is then stored in the database module 112 at step 302. The client configuration information is compared to vendor software and hardware information, including product specifications, to identify client software in need of update at step 303. At step 303 various data processing techniques are used to create various recommendations based on the gathered data and identification of software update. The recommendation data is communicated electronically via network to client configuration management program on the client computer system at step 304.

Methods for making recommendations related to statistical analysis of client computer system configurations may use a wide range of techniques, including simple category-based inferences, learning algorithms, neural nets, regression analysis and other statistical techniques, or the like. An example of such techniques may include collaborative filtering techniques that make use of the collection of configuration data from a large group of clients. A client system configuration data may be analyzed statistically to identify subgroups, or characteristics of subgroup members, with similar configuration profiles. Various weighted average, fuzzy logic, or other techniques may be used to summarize or model a preference subgroup, and a preference function may be created using the model/summary. Recommendation may be generated from determining how a client's system configuration align with and/or differs from other clients having similar system configurations.

In embodiments of the method and system, a statistical association may determine the relevance of particular components in a client computer system configuration. A statistical association value may be used to rank components of a client system configuration as compared to the aggregation of client system configurations according to a client preference subgroup, characteristics of subgroup members, or location-based subgroups. For example, a client may be interested in how her RAM memory configuration compare to other computer system configurations in her company (a location-based subgroup according to network address in the system configuration data).

The statistical analysis performed on the aggregated data may take various forms and the system may be configured to generate and issue reports of the analysis. Reports may be regionalized or world-wide depending on what information is desired. It is feasible for example to report on data aggregated from numerous client computers in a specific region (e.g., Europe, N. America, Asia Pacific, etc . . . ) or to report on data taken from all or any definable geographic region. Systems embodying one or more aspects of the system may generate penetration reports that show what different graphics cards are in use in a specific area (e.g., San Francisco). Other reports such as what the geographic reach of computers from a specific location might also be generated. It would be plausible for example to determine what the installation base is for any given product (e.g., Photoshop™) in a given city (e.g., New York), state, country or region.

The system can provide the reports on a scheduled or on demand basis depending upon what reporting interval is desired. When the same report is run at varying intervals a comparison that points out the differences between the two reports may be contained in the reports or separately executed. This provides users with the ability to trace changes between the different reporting intervals.

The system may also generate reports that identify what specific hardware is used throughout the systems that makeup the aggregated data. A report that for instance identifies what % of computers (e.g., the top 5 computer models) contain a specific graphics card, sound card, printer, scanner or other peripheral or related device may be run. Other variations are also feasible such as what manufacture has the most disperse geographic reach or other trends related to what hardware is installed and being used throughout the computers reporting into the aggregated data set.

The system may also generate reports defining what software is installed throughout the various geographic regions and formulate other reports that show what software is installed on various machines and being used throughout the user population of computers making a contribution to the aggregated data. The system may determine for instance what % of computers contain an anti-virus, firewall or other security solution. In other cases reports are generated about what software is used as an anti-virus solution, firewall solution, web browser, instant messenger, word processor or any other generalized category of software. Hence the report could show which anti-virus solution is most widely used by percentage and what might be the closest second runner up. Variations such as what the hardware platform is and what software is installed as a complement to or in conjunction with the software under analysis. The system may also identify what camera software and photo-editing tool is installed across the group of computers in the aggregated data set.

Correlations between the different values within the aggregated data set and/or any other type of statistical analysis are within the scope and spirit of the invention. Using the aggregated data as the basis for analysis the system may generate reports than identify what commonalities exists among certain user populations. Hence the system may determine of people who installed a certain software program a percentage of those people also installed an additional program. (e.g., people who installed X Software [Adobe Photoshop], also installed Y: 90% installed Office, 82% installed Eudora, etc.). Comparative analysis between hardware and software solutions is also feasible and hence the system may, for instance, determine that users that installed X hardware [e.g. HP 88766 Scanner] also installed hardware X and software Y.

A recommendation system may use information from a client system configuration data to make predictions regarding other software/hardware that might interest the client. Data used in the recommendation system may be obtained through the use of implicit data collection. Implicit collection refers to data collected as, for example, a byproduct of user behavior, such as software and hardware components installed on the computer system. The recommendation system may compare the collected data to similar data collected from others and calculates a list of recommended items for clients. E.g., a computer system indicative of a graphic artist subgroup may generate statistical analysis results for graphic software, graphic card, printer, and/or memory components when making recommendations.

Client preferences may be inferred from implicit characteristics found in configuration data. Clients may implicitly register a preference through system configuration data such as data indicative of types of software, peripherals, and hardware. For example, if the client configuration data indicates a color printer, scanner, and photo editing software, one can draw an inference that the client may be interested in a recommendation of a digital camera, and this inference may be used as part of a collaborative filtering algorithm. In addition, inferences may be drawn from the types of establishment the client has been using the configuration management system by determining data indicative of particular types of software (e.g. business productivity software).

While the invention herein disclosed has been described by means of specific embodiments and applications thereof, numerous modifications and variations could be made thereto by those skilled in the art without departing from the scope of the invention set forth in the claims.

What is claimed is:

1. A system for providing software update service and analyzing aggregated data from a plurality of computers having said software update service, comprising:
one or more client computer system coupled to a communications network, each having a client configuration management program that comprises a scanner program;
a server device configured for communications via said communications network, having a server program that is configured for retrieving a configuration data indicative of said computer system;
wherein said that the configuration data comprises hardware, software and driver information;
said configuration data is then checked to determine if the configuration of said client computer system is current;
said configuration data is stored with a set of aggregated configuration data on a database of said server device;
wherein said server program having a database program that is configured to analyze said configuration data against said set of aggregated configuration data; and,
wherein said server program that is also configured for sending to said computing devices having said client module an recommendation data.

2. The system of claim 1 wherein said server program that is further configured for sending to said computing devices a update data indicative of a set of software updates.

3. The system of claim 2 wherein said client module is configured to enable said computing device to update software.

4. The system of claim 1 further comprising:
a web server device configured to upload said client module to said computing devices through said communications network.

5. The system of claim 4, wherein said web server device comprises a software repository.

6. The system of claim 5 wherein said software repository comprises a software.

7. The system of claim 6 wherein said software is driver.

8. The system of claim 1 wherein said scanner program scans computer readable medium of said computing device for data indicative of software and hardware configuration.

9. The system of claim 8 wherein said hardware configuration comprises at least one of or a combination of USB peripheral device, non-USB peripheral device, PCI device, graphic processor, chipset, memory module, physical hardware interface, networking chip, memory controller, north bridge chip, south bridge chip, paged memory management unit, CPU, vector coprocessor, FPU, hard drive controller,

10. The system of claim 9 wherein said USB device is one selected from the group consisting of printer, flash card reader, scanner, digital camera, multifunction printer, fax machine, mouse, track pad, stylus tablet, bar code reader,

11. The system of claim 9 wherein said non-USB peripheral device is a IEEE-1394 peripheral device.

12. The system of claim 9 wherein PCI device comprises graphic card, sound board, networking card, coprocessor board, hard drive controller board,

13. The system of claim 9 wherein hard drive controller is one selected from the group consisting of SCSI controller, ATA controller, IDE controller, ATAPI controller, and UDMA controller.

14. The system of claim 1 wherein said scanner module scans computer hardware for data indicative of a hardware information of said computing device.

15. The system of claim 1 wherein said server device comprises a software repository.

16. The system of claim 1 wherein said computing device having an operating system is selected from the group consisting of Linux, Windows, Windows Compact Edition, Macintosh, and Pocket PC.

17. A method for providing software update service, said method comprising:
providing a client module to a networked computing device, wherein client module scans said networked computing device for a configuration information;
receiving client configuration information from said client module;
determining that updated software is available;
generating recommendations from said configuration information based at least on one parameter;
providing said client module with a software update information and said recommendations; and
enabling said client module to provide software updates.

18. The method of claim 17, wherein said software updates comprise a driver.

19. The method of claim 17 wherein said configuration information comprises software and hardware configuration.

20. The method of claim 17 wherein the step of providing said client module is initiated at the request of a user of said networked computing device.

21. The method of claim 17 wherein said generating recommendations is an implicit search.

22. The method of claim 17 wherein said generating recommendations is an collaborative filtering.

23. The method of claim 17 wherein said generating recommendation is a ranking of said parameter by a statistical association.

24. The method of claim 17 wherein said parameter is software type.

25. The method of 17 wherein said parameter is hardware type.
